(19) United States
(12) Patent Application Publication
(10) Pub. No.: US 2023/0047041 A1
(43) Pub. Date: Feb. 16, 2023

(54) USER SAFETY AND SUPPORT IN SEARCH AND RESCUE MISSIONS

(71) Applicant: International Business Machines Corporation, Armonk, NY (US)

(72) Inventors: Edward C. McCain, Lagrangeville, NY (US); Heather Nicole Polgrean, Lagrangeville, NY (US); Ali Haider, Harrison, NJ (US); Marc Henri Coq, Hopewell Junction, NY (US); Megan Elizabeth Hampton, Poughkeepsie, NY (US)

(21) Appl. No.: 17/398,093

(22) Filed: Aug. 10, 2021

(51) Int. Cl. G08G 5/00; G06K 9/00; B64C 39/02

(52) U.S. Cl. CPC G08G 5/003; B64C 39/024; G06K 9/0063; B64C 2201/127; B64C 2201/145

(57) ABSTRACT

Locating, aiding, and communicating with users and personnel in emergency situations by traversing a defined path utilizing an unmanned vehicle, detecting a user within a threshold distance of the defined path, logging a geolocation of the user within the unmanned vehicle, and determining whether to dispatch assistance to the user.

### BACKGROUND

The disclosure relates generally to surveillance of a defined area. The disclosure relates particularly to locating, aiding, and communicating with users and personnel in emergency situations.

Surveillance is the monitoring of behavior, activities, or information for the purpose of information gathering, influencing, managing or directing. This can include observation from a distance by means of electronic equipment. Surveillance is used for intelligence gathering, the protection of a process, person, group or object, or the investigation of crime.

Aerial surveillance is the gathering of surveillance, usually visual imagery or video, from an airborne vehicle—such as an unmanned aerial vehicle, helicopter, or spy plane. Digital imaging technology, miniaturized computers, and numerous other technological advances over the past decade have contributed to rapid advances in aerial surveillance hardware such as micro-aerial vehicles, forward-looking infrared, and high-resolution imagery capable of identifying objects at extremely long distances.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable locating, aiding, and communicating with users and personnel in emergency situations.

Aspects of the invention disclose methods, systems and computer readable media associated with locating, aiding, and communicating with users and personnel in emergency situations by traversing a defined path utilizing an unmanned vehicle, detecting a user within a threshold distance of the defined path, logging a geolocation of the user within the unmanned vehicle, and determining whether to dispatch assistance to the user.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

FIG. 3 provides a flowchart depicting an operational sequence, according to an embodiment of the invention.

FIG. 4 provides a flowchart depicting an operational sequence, according to an embodiment of the invention.

FIG. 5 depicts a cloud computing environment, according to an embodiment of the invention.

FIG. 6 depicts abstraction model layers, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

Various embodiments of the present disclosure recognize that hiking is a common source of injury in the wild, accounting for thousands of deaths annually. Also, falls account for 17% of all unintentional deaths and thousands of injuries annually. Embodiments of the present disclosure provide a system and method to locate, assist, and communicate with hikers and personnel in emergency situations where time is of the essence. Additionally, hikers are often without cellular service, local access networks, or any other method of communication in the event of an emergency. Embodiments of the present disclosure solve connectivity issues by utilizing an unmanned vehicle to enable communication with a user in the event of an emergency.

In an embodiment, one or more components of the system can employ hardware and/or software to solve problems that are highly technical in nature (e.g., a graded analysis of falls to determine severity and possible necessity of emergency services, etc.). These solutions are not abstract and cannot be performed as a set of mental acts by a human due to the processing capabilities needed to facilitate operations to allow an unmanned vehicle to perform surveillance missions and interact with users regardless of telecommunications access or access to a computer network, for example. Further, some of the processes performed may be performed by a specialized computer for carrying out defined tasks related to locating, aiding, and communicating with users and personnel in emergency situations. For example, a specialized computer can be employed to carry out tasks related to processing verbal responses of a user or the like.

Implementation of embodiments of the invention may take a variety of forms, and exemplary implementation details are discussed subsequently with reference to the Figures.

In an embodiment, a system executing user safety and support method to locate, assist, and communicate with users and support in emergency. In the embodiment, the method traverses a defined path utilizing an unmanned vehicle. For example, a defined path can include, but is not limited to hiking trails of maps and paths between a location of an unmanned vehicle and identified geolocations of a user. In another example, an unmanned vehicle can include, but is not limited to autonomous vehicles and unmanned aerial vehicles (UAVs), which can be equipped with resources to captures images, store data, and communicate with one or more computing devices. The method utilizes the unmanned vehicle to monitor the defined path to locate, assist, and communicate with users in emergency situations.

In another embodiment, the method defines a defined path of an unmanned vehicle using a corpus (e.g., database) of locations of the defined path that correspond to user incident rates. In this embodiment, the method defines the defined path of the unmanned vehicle based on one or more locations of the corpus. For example, the method can define a path for an unmanned vehicle to traverse based on segments (e.g., a collection of locations) and/or locations with the highest value associated with incidents (e.g., accidents, injuries, falls, etc.). In another example, the method can collect incident data (e.g., location, incident types, injuries, etc.) and generate a corpus of locations of a geographical area correlated with occurrences of user incidents. In this example, the method can collect incident data from an unmanned vehicle and/or various other sources (e.g., user device, crowdsourced data, etc.).

In another embodiment, the method utilizes an unmanned vehicle to query one or more computing devices of one or more users traversing a defined path for feedback corresponding to a user. For example, in response to receiving a generated report that a user has not checked out, the method can utilize an unmanned vehicle to query mobile devices of users the unmanned vehicle encounters while traversing a defined path (e.g., last known location of the user) for location information (e.g., geolocation, feedback information, etc.) of the user. The method can utilize the location information received from the one or more computing devices to redefine a path of the unmanned vehicle.

In another embodiment, the method detects a user traversing a defined path. In the embodiment, the method can utilize a wireless personal access network of an unmanned vehicle to identify one or more users within a threshold distance of the defined path. For example, the communications capabilities of an unmanned vehicle define a threshold distance. Additionally, the method receives confirmation of a detected user from the unmanned vehicle. For example, the method utilizes an unmanned vehicle to transmit a broadcast message (e.g., signal, beacon, assistance signal, etc.) as the unmanned vehicle traverses the defined path. In this example, the unmanned vehicle monitors and detects response signals (e.g., distress signals, confirmation messages, etc.) of users within a defined threshold distance. In the event the unmanned vehicle receives a response signal, the method receives confirmation of the response signal and provides the unmanned vehicle with instructions to transmit a message to the user confirming an assistance request.

In an embodiment, the method utilizes an unmanned vehicle to log location information of users, assistance request, incidents, and/or coverage updates. The method utilizes global positioning system information of the unmanned vehicle to log locations of a defined path relevant to users, progress, and/or incidents. In an embodiment, the unmanned vehicle stores a log of locations in a database and transmits the log to the method once connectivity to a communications network is accessible.

In an embodiment, the method determines whether to dispatch assistance to a user. In the embodiment, the method utilizes a response signal of a computing device of the user that may include a confirmation method to determine whether to dispatch assistance to the user. In this embodiment, the method can dispatch assistance to the user based on the response signal of the computing device of the user.

In another embodiment, the method determines whether to dispatch assistance to a user based on sensor information of a computing device of the user. In this embodiment, the method receives sensor information of the computing device of the user from an unmanned vehicle via a connection (e.g., WPAN, etc.) of the unmanned vehicle, which enables the user to communicate an assistance request in an area without access to a cellular network or wireless local area network (WLAN). In the embodiment, the method identifies a fall event corresponding to the user using the sensor information. In this embodiment, the method can dispatch assistance to the user based on the sensor information of the computing device of the user.

In another embodiment, the method utilizes a client-side application (e.g., the method) of a computing device of the user to collect sensor information of the user. In this embodiment, the method is granted access to collect the sensor information when the user opts-in and installs the client-side application. The method utilizes the client-side application to detect changes in readings of sensors (e.g., accelerometer, gyroscope, barometer, etc.), determine that a fall event is occurring based on the changes in readings of sensors, and records the sensor information until readings of the sensors indicate the computing device of the user is at rest. Additionally, the method utilizes the sensor information to rank the fall event to determine a severity of injury the user is probable to experience.

In an example embodiment, a user trips and falls on a trail, rolling over once before coming to a stop, resulting in a scrape to a knee of the user. In the example, embodiment, the method receives sensor information that indicates an accelerometer detecting a downward momentum of a computing device of the user, a barometer detecting a fall of approximately three (3) feet, and a gyroscope detecting one complete rotation of the computing device. In this example embodiment, a client-side application of the method on the computing device stores a geolocation of the computing device until an unmanned vehicle receives the stored sensor information and transmits the stored sensor information to the method. The method utilizes the sensor information to assign a rank of one (1) to a fall event corresponding to the sensor information on a scale of one (1) to three (3) where (3) is the indicates a high severity of assistance required.

In an example embodiment, a user slips off a low ledge of a trail, falling six (6) feet to the ground below, resulting in the user twisting an ankle and being unable to continue walking. In the example embodiment, the method receives sensor information that indicates an accelerometer detecting a downward momentum of a computing device of the user, a barometer detecting a fall of approximately six (6) to twelve (12) feet, and a gyroscope detecting one or more rotations of the computing device. In this example embodiment, a client-side application of the method on the computing device stores a geolocation of the computing device until an unmanned vehicle receives the stored sensor information and transmits the stored sensor information to the method. The method utilizes the sensor information to assign a rank of two (2) to a fall event corresponding to the sensor information on a scale of one (1) to three (3) where (3) indicates a high severity of assistance is required. In the example embodiment, the method provides a message to the computing device of the user that prompts the user to confirm whether injured or uninjured and the unmanned vehicle can collect relevant data (e.g., response, injuries, location, etc.), stores the relevant data, and continuing traversing a defined path. In the example embodiment, the method provides a message to the computing device of the user that prompts the user to confirm whether assistance is required, because the method can predict injuries are probable based on rank assigned to sensor information. If the method detects no response from the user, then the method can assume assistance is required and dispatch assistance (e.g., notify personnel, notify other users, etc.).

In an example embodiment, a user caught in a rockslide, traveling greater than twelve (12) feet downward, trapping the user with high probability of severe injuries requiring immediate medical attention. In the example embodiment, the method receives sensor information that indicates an accelerometer detecting a downward momentum of a computing device of the user, a barometer detecting a fall of greater than twelve (12) feet, and a gyroscope detecting multiple rotations of the computing device. In this example embodiment, a client-side application of the method on the computing device stores a geolocation of the computing device until an unmanned vehicle receives the stored sensor information and transmits the stored sensor information to the method. The method utilizes the sensor information to assign a rank of three (3) to a fall event corresponding to the sensor information on a scale of one (1) to three (3) where (3) indicates a high severity of assistance is required. In the example embodiment, the method provides a message to the computing device of the user that prompts the user to confirm whether assistance is required, because the method can predict injuries are probable based on rank assigned to sensor information. If the method detects no response from the user, then the method can assume assistance is required and dispatch assistance (e.g., notify personnel, notify other users, contact emergency service, etc.).

In another embodiment, the method can utilize a client-side application (e.g., mobile application, etc.) of a computing device of a user to perform a defined task based on sensor information of the computing device of the user. In the embodiment, the method can receive confirmation for dispatch assistance from the computing device of the user. The method can also utilize an unmanned vehicle to perform the defined task. For example, a defined task is an action performed by a computing device of the user and/or an unmanned vehicle. In this example, the method utilizes the unmanned vehicle to provide a message prompt (e.g., are you injured, do you require assistance, etc.) to the user and/or the computing device of the user. Also, a response to the message prompt can be vocal (e.g., audible speech), which the method can utilize natural language processing (NLP) techniques (e.g., speech to text, natural language understanding, etc.) to process the response. In an alternative example, the method utilizes the unmanned vehicle to capture images (e.g., visible spectrum, infrared, etc.) of an area corresponding to a geolocation of a user. In this example, the method can utilize a machine learning model (e.g., support vector machine, convolutional neural network, etc.) to perform object-class detection tasks to detect a face of an injured user within a defined area and/or detect a human from the captured images of the unmanned vehicle.

In an embodiment, the method dispatches assistance to a user. In the embodiment, the method provides a dispatch unit to a geolocation of the user to assist the user. For example, the method utilizes an unmanned vehicle to notify personnel. In this example, the unmanned vehicle can identify a base station closest in proximity to a geolocation of a user, travel to the base station, and dispatch assistance (e.g., personnel, emergency services, etc.) to geolocation of the user. Additionally, the method utilizes the unmanned vehicle to notify other users within proximity of the user or along a defined path of the unmanned vehicle to the base station. In another example, the method utilizes an unmanned vehicle to convoy emergency response vehicles (e.g., automobiles, helicopters, etc.) to a geolocation of a user and/or hazardous area. In this example, the method utilizes information corresponding to defined paths of a database and/or the unmanned vehicle to plot the most efficient course for the emergency response vehicles or notify other users of safe passages to avoid the hazardous area.

In various embodiments of the present disclosure the method provides unique operation to enable an unmanned vehicle to perform routine surveillance tasks and interact with users regardless of telecommunications coverage or access to WLAN. The method utilizes an onboard hotspot of the unmanned vehicle to ensure communication with users in the event users request/require assistance (i.e., allows connection of unmanned vehicle to phone and vice versa). Additionally, the method enables an unmanned vehicle to access a database of defined paths with corresponding statistics on the most common areas of incidents and utilize this information to prioritize areas of highest probability when attempting to locate missing and/or injured users. Also, the method generates a graded analysis of falls to determine severity and corresponding assistance type (e.g., necessity of emergency services, guidance, etc.). Furthermore, the method enables cooperative operation with a downloadable app allowing the unmanned vehicle to utilize the internal hardware (accelerometers, gyroscopes, etc.) of a computing device (e.g., mobile phone) to determine severity of a fall. The method utilizes the unmanned vehicle and database to eliminate the need for a physical sign in book and allow real time search and rescue operations. As a result, various embodiments of the present disclosure can be performed in response to receiving a report, which the method utilizes to identify inconsistencies (e.g., indication of missing user), that can include entry/exit data for users within a defined area.

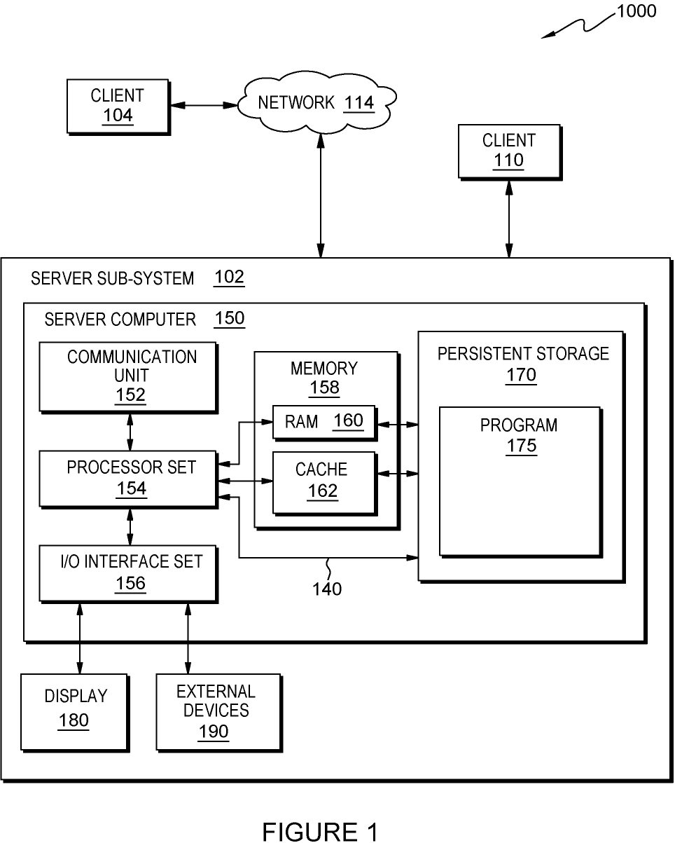

FIG. 1 provides a schematic illustration of exemplary network resources associated with practicing the disclosed inventions. The inventions may be practiced in the processors of any of the disclosed elements which process an instruction stream. As shown in the figure, a networked Client device 110 connects wirelessly to server sub-system 102. Client device 104 connects wirelessly to server sub-system 102 via network 114. Client devices 104 and 110 comprise application program (not shown) together with sufficient computing resource (processor, memory, network communications hardware) to execute the program. In an embodiment, client devices 104 and 110 can communicate via network 114, which may be a wireless personal access network (WPAN) of client devices 104 or 110.

As shown in FIG. 1, server sub-system 102 comprises a server computer 150. FIG. 1 depicts a block diagram of components of server computer 150 within a networked computer system 1000, in accordance with an embodiment of the present invention. It should be appreciated that FIG. 1 provides only an illustration of one implementation and does not imply any limitations with regard to the environments in which different embodiments can be implemented. Many modifications to the depicted environment may be made by those skilled in the art without departing from the scope of the invention as recited by the claims.

The present invention may contain various accessible data sources, such as Client devices 104 and 110 and memory 158, that may include personal data, content, or information the user wishes not to be processed. Personal data includes personally identifying information or sensitive personal information as well as user information, such as tracking or geolocation information. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Program 175 enables the authorized and secure processing of personal data. Program 175 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Program 175 provides information regarding personal data and the nature (e.g., type, scope, purpose, duration, etc.) of the processing. Program 175 provides the user with copies of stored personal data. Program 175 allows the correction or completion of incorrect or incomplete personal data. Program 175 allows the immediate deletion of personal data.

Server computer 150 can include processor(s) 154, memory 158, persistent storage 170, communications unit 152, input/output (I/O) interface(s) 156 and communications fabric 140. Communications fabric 140 provides communications between cache 162, memory 158, persistent storage 170, communications unit 152, and input/output (I/O) interface(s) 156. Communications fabric 140 can be implemented with any architecture designed for passing data and/or control information between processors (such as microprocessors, communications and network processors, etc.), system memory, peripheral devices, and any other hardware components within a system. For example, communications fabric 140 can be implemented with one or more buses.

Memory 158 and persistent storage 170 are computer readable storage media. In this embodiment, memory 158 includes random access memory (RAM) 160. In general, memory 158 can include any suitable volatile or non-volatile computer readable storage media. Cache 162 is a fast memory that enhances the performance of processor(s) 154 by holding recently accessed data, and data near recently accessed data, from memory 158.

Program instructions and data used to practice embodiments of the present invention, e.g., program 175, are stored in persistent storage 170 for execution and/or access by one or more of the respective processor(s) 154 of server computer 150 via cache 162. In this embodiment, persistent storage 170 includes a magnetic hard disk drive. Alternatively, or in addition to a magnetic hard disk drive, persistent storage 170 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 170 may also be removable. For example, a removable hard drive may be used for persistent storage 170. Other examples include optical and magnetic disks, thumb drives, and smart cards that are inserted into a drive for transfer onto another computer readable storage medium that is also part of persistent storage 170.

Communications unit 152, in these examples, provides for communications with other data processing systems or devices, including resources of client computing devices 104, and 110. In these examples, communications unit 152 includes one or more network interface cards. Communications unit 152 may provide communications through the use of either or both physical and wireless communications links. Software distribution programs, and other programs and data used for implementation of the present invention, may be downloaded to persistent storage 170 of server computer 150 through communications unit 152.

I/O interface(s) 156 allows for input and output of data with other devices that may be connected to server computer 150. For example, I/O interface(s) 156 may provide a connection to external device(s) 190 such as a keyboard, a keypad, a touch screen, a microphone, a digital camera, and/or some other suitable input device. External device(s) 190 can also include portable computer readable storage media such as, for example, thumb drives, portable optical or magnetic disks, and memory cards. Software and data used to practice embodiments of the present invention, e.g., program 175 on server computer 150, can be stored on such portable computer readable storage media and can be loaded onto persistent storage 170 via I/O interface(s) 156. I/O interface(s) 156 also connect to a display 180.

Display 180 provides a mechanism to display data to a user and may be, for example, a computer monitor. Display 180 can also function as a touch screen, such as a display of a tablet computer.

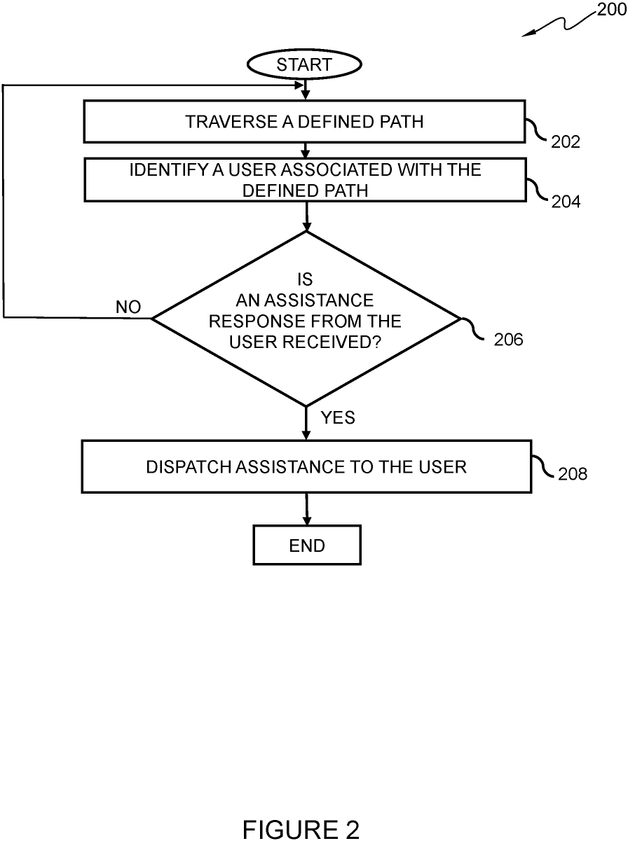

FIG. 2 provides a flowchart 200, illustrating exemplary activities associated with the practice of the disclosure. In one embodiment, program 175 initiates in response to a user connecting client device 104 to program 175 through network 114. For example, program 175 initiates in response to a user registering (e.g., opting-in) a mobile phone (e.g., client device 104) with bill program 200 via a WLAN (e.g., network 110).

After program start, at block 202, the method of surveillance program 175 traverses a defined path. In an embodiment, the method utilizes client device 110 to traverse a defined path.

At block 204, the method of surveillance program 175, identifies a user associated with the defined path. In an embodiment, the method utilizes client device 110 to detect client device 104 and/or a user. In another embodiment, the method receives image and textual data from client device 110 to identify client device 104 and/or a user.

At block 206, the method of surveillance program 175, determines whether an assistance response is received from the user. In an embodiment, the method utilizes client device 110 to receive a response from client device 104 and/or a user to a request of client device 110. In one embodiment, if the method determines that a non-affirmative response to a request of client device 110 is received from client device 104, then client device 110 collects relevant information from client device 104 and continue to traverse the defined path. In another embodiment, if the method determines that an affirmative response to a request of client device 110 is received from client device 104, then client device 110 collects relevant information from client device 104 and continues to traverse the defined path.

At block 208, the method of surveillance program 175, dispatches assistance to the user. In an embodiment, the method utilizes client device 110 to dispatch assistance to client device 104. In another embodiment, the method utilizes client device 110 to provide assistance to client device 104 and/or a user.

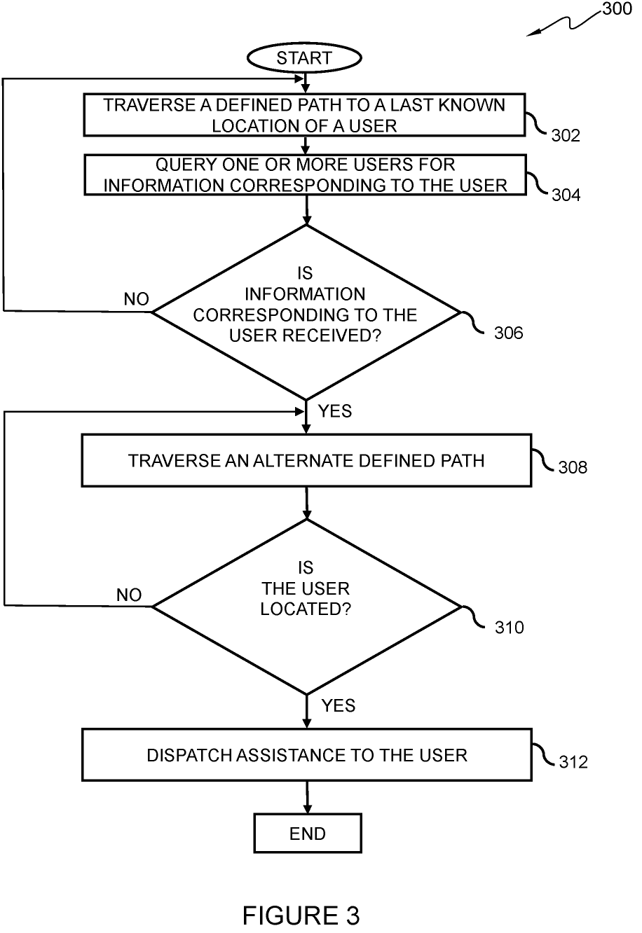

FIG. 3 provides a flowchart 300, illustrating exemplary activities associated with the practice of the disclosure. In one embodiment, program 175 initiates in response to identifying an indication of an incident from a received report. For example, program 175 deploys an unmanned vehicle (e.g., client device 110) to a geolocation of a mobile device (e.g., client device 104) of a user in response to program 175 identifying an indication of an incident of a received report.

After program start, at block 302, the method of surveillance program 175 traverses a defined path to a last known location of a user. In an embodiment, the method utilizes client device 110 to traverse a defined path to a geolocation of client device 104.

At block 304, the method of surveillance program 175, queries one or more users for information corresponding to the user. In an embodiment, the method utilizes client device 110 to transmit a query to one or more instances of client device 104 of one or more users for information corresponding to a user. In this embodiment, client device 110 queries the one or more instances of client device 104 of one or more users within a threshold distance of a defined path of client device 110.

At block 306, the method of surveillance program 175, determines whether information corresponding to the user is received. In an embodiment, the method utilizes client device 110 to receive information of a response of one or more instances of client device 104 of one or more users to a request of client device 110. In one embodiment, if the method determines that irrelevant information of a user to a request of client device 110 is received from one or more instances of client device 104 of one or more users, then client device 110 continues to traverse a defined path to the user. In another embodiment, if the method determines that relevant information of a user to a request of client device 110 is received from one or more instances of client device 104 of one or more users, then client device 110 collects relevant information from client device 104 and redefines a defined path to the user based on the relevant information (i.e., traversing an alternate defined path).

At block 308, the method of surveillance program 175, traverses an alternative defined path. In an embodiment, the method utilizes client device 110 to traverse a redefined path to a geolocation of client device 104. In another embodiment, the method utilizes client device 110 to traverse an alternate path to a geolocation of client device 104 utilizing a database of memory 158 or client device 110.

At block 310, the method of surveillance program 175, determines whether the user is located. In an embodiment, the method utilizes client device 110 to locate a user of client device 104. In another embodiment, the method utilizes a machine learning model and images of client device 110 to locate a user of client device 104. In one embodiment, if the method determines that client device 110 does not locate a user of client device 104, then the method continues to utilize client device 110 to traverse the defined path or alternative defined paths until all paths are traversed. In another embodiment if the method determines that client device 110 locates a user of client device 104, then the method continues to utilize client device 110 to provide assistance to the user of client device 104.

At block 312, the method of surveillance program 175, dispatches assistance to the user. In an embodiment, the method utilizes client device 110 to dispatch assistance to a user of client device 104. In another embodiment, the method utilizes client device 110 to provide assistance to a user of client device 104.

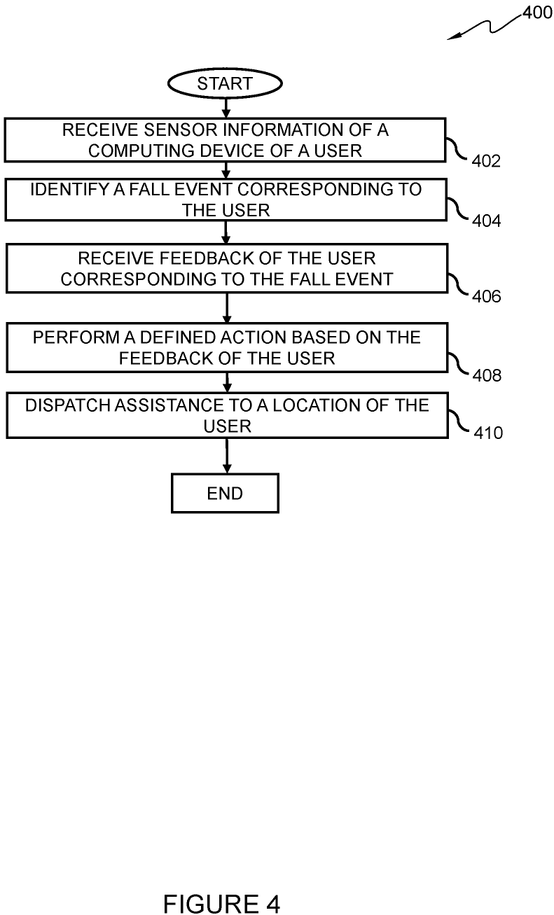

FIG. 4 provides a flowchart 400, illustrating exemplary activities associated with the practice of the disclosure. In one embodiment, program 175 initiates in response to receiving sensor information of client device 104. For example, in response to receiving sensor information of a mobile device (e.g., client device 104) program 175 determines a fall event of a user of client device 104.

After program start, at block 402, the method of surveillance program receives sensor information of a computing device of a user. In an embodiment, the method receives sensor information of client device 104. In another embodiment, the method receives sensor information of client device 104 from client device 110.

At block 404, the method of surveillance program 175 identifies a fall event corresponding to the user. In an embodiment, the method utilizes sensor information of client device 104 to identify a fall event of a user. In another embodiment, the method receives sensor information of client device 104 from client device 110 and determines fall event of a user using the sensor information. In another embodiment, the method utilizes a client-side application of client device 104 to detect a fall event and store the sensor information of client device 104 for upload to the method or client device 110.

At block 406, the method of surveillance program 175, receives feedback of the user corresponding to the fall event. In an embodiment, the method utilizes client device 110 to transmit a message prompt to client device 104. In another embodiment, the method utilizes a client-side application of client device 104 to transmit a message prompt to a user of client device 104. In yet another embodiment, the method receives a response to a message prompt from a user of client device 104 from client device 110.

At block 408, the method of surveillance program 175, performs a defined action based on the feedback of the user. In an embodiment, the method utilizes client device 110 to perform a defined action based on a response of a user of client device 104. In one embodiment, if the method determines that a response of a user to a message prompt of client device 104 indicates the user is not injured, then the method collects information corresponding to the fall event continues traversing a defined path. In another embodiment, if the method determines that a response of a user to a message prompt of client device 104 indicates the user is injured, then the method dispatches assistance to the user based on the response and/or sensor information of client device 104.

In another embodiment, the method utilizes client device 110 to perform a defined action based on a non-response of a user of client device 104. In yet another embodiment, the method monitors for a response to a message prompt of client device 104 for a defined period of time. In one embodiment, if the method determines that no response of a user to a message prompt of client device 104 is received within the defined period of time and the sensor data indicates the user is injured (i.e., based on an assigned rank of the fall event), then the method utilizes client device 110 to collect information corresponding to the fall event and dispatch assistance to the user based on an assigned rank and/or sensor information of client device 104.

At block 410, the method of surveillance program 175, dispatches assistance to the user. In an embodiment, the method utilizes client device 110 to dispatch assistance to a user of client device 104. In another embodiment, the method utilizes client device 110 to provide assistance to a user of client device 104.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

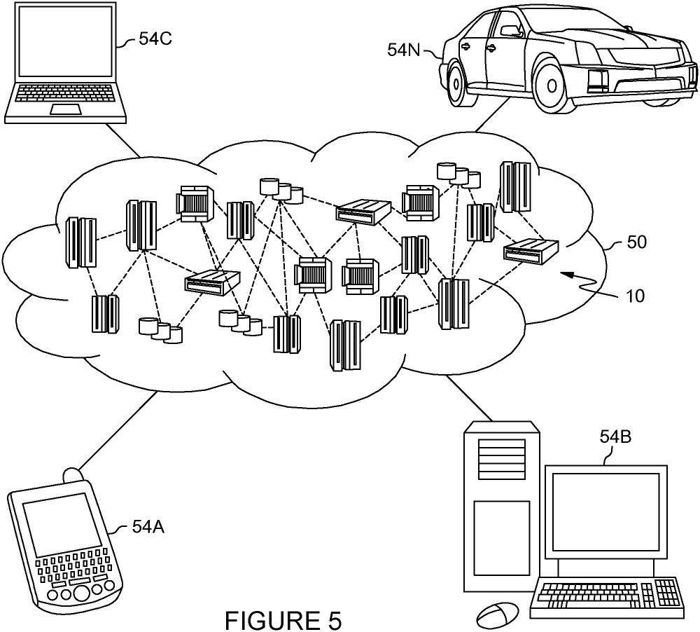

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

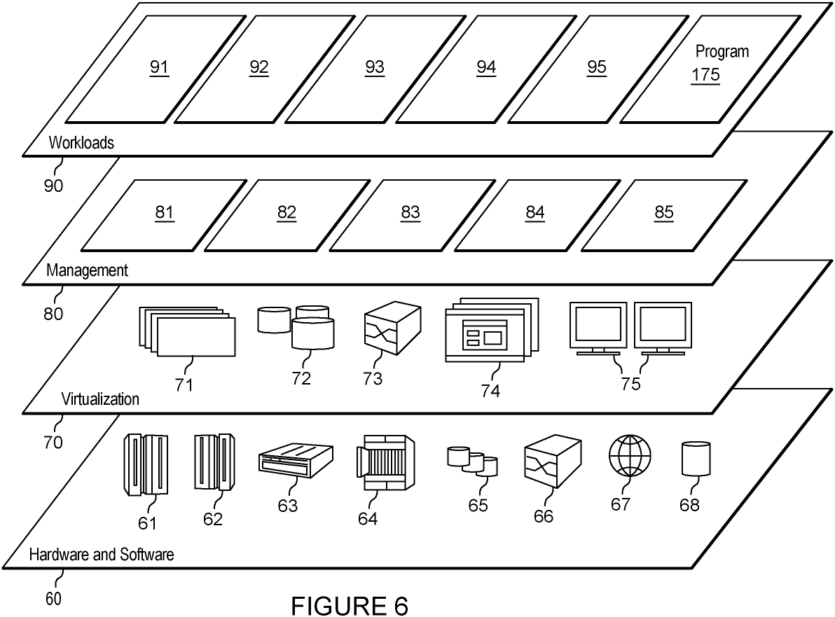

Referring now to FIG. 6, a set of functional abstraction layers provided by cloud computing environment 50 (FIG. 5) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and learning program 175.

The present invention may be a system, a method, and/or a computer program product at any possible technical detail level of integration. The invention may be beneficially practiced in any system, single or parallel, which processes an instruction stream. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, or computer readable storage device, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method comprising:
traversing a defined path utilizing an unmanned vehicle;
detecting a user within a threshold distance of the defined path;
logging a geolocation of the user within the unmanned vehicle; and
determining whether to dispatch assistance to the user.

2. The computer implemented method according to claim 1, further comprising:
in response to determining to dispatch assistance to the user, providing a dispatch unit to the geolocation of the user.

3. The computer implemented method according to claim 1, further comprising:
querying computing devices of one or more users for feedback corresponding to the user; and
redefining the defined path of the unmanned vehicle based at least in part on the feedback of the one or more users.

4. The computer implemented method according to claim 1, wherein determining whether to dispatch assistance to the user, further comprises:
receiving sensor information of a computing device of the user from the unmanned vehicle; and
identifying a fall event corresponding to the user based at least in part on the sensor information.

5. The computer implemented method according to claim 4, further comprising:
capturing images of an area corresponding to the fall event; and
receiving confirmation for dispatch assistance from the computing device of the user.

6. The computer implemented method according to claim 1, wherein detecting the user within the threshold distance of the defined path, further comprises:
transmitting an assistance signal to one or more computing devices within the threshold distance of the defined path, wherein the threshold distance is based on communication capabilities of the unmanned vehicle; and
receiving confirmation of a response to the assistance signal from the unmanned vehicle.

7. The computer implemented method according to claim 1, further comprising:
redefining the defined path based at least in part on a corpus of segments of the defined path with corresponding user incident rates.

8. A computer program product comprising one or more computer readable storage devices and collectively stored program instructions on the one or more computer readable storage devices, the stored program instructions comprising:
program instructions to traverse a defined path utilizing an unmanned vehicle;
program instructions to detect a user within a threshold distance of the defined path;
program instructions to log a geolocation of the user within the unmanned vehicle; and
program instructions to determine whether to dispatch assistance to the user.

9. The computer program product according to claim 8, the stored program instructions further comprising:
in response to determining to dispatch assistance to the user, program instructions to provide a dispatch unit to the geolocation of the user.

10. The computer program product according to claim 8, the stored program instructions further comprising:
program instructions to query computing devices of one or more users for feedback corresponding to the user; and
program instructions to redefine the defined path of the unmanned vehicle based at least in part on the feedback of the one or more users.

11. The computer program product according to claim 8, wherein determining whether to dispatch assistance to the user, further comprises:
program instructions to receive sensor information of a computing device of the user from the unmanned vehicle; and
program instructions to identify a fall event corresponding to the user based at least in part on the sensor information.

12. The computer program product according to claim 11, the stored program instructions further comprising:
program instructions to capture images of an area corresponding to the fall event; and
program instructions to receive confirmation for dispatch assistance from the computing device of the user.

13. The computer program product according to claim 8, wherein detecting the user within the threshold distance of the defined path, further comprises:
program instructions to transmit an assistance signal to one or more computing devices within the threshold distance of the defined path, wherein the threshold distance is based on communication capabilities of the unmanned vehicle; and
program instructions to receive confirmation of a response to the assistance signal from the unmanned vehicle.

14. The computer program product according to claim 8, the stored program instructions further comprising:
program instructions to redefine the defined path based at least in part on a corpus of segments of the defined path with corresponding user incident rates.

15. A computer system comprising:
one or more computer processors;
one or more computer readable storage devices; and
stored program instructions on the one or more computer readable storage devices for execution by the one or more computer processors, the stored program instructions comprising:
program instructions to traverse a defined path utilizing an unmanned vehicle;
program instructions to detect a user within a threshold distance of the defined path;
program instructions to log a geolocation of the user within the unmanned vehicle; and
program instructions to determine whether to dispatch assistance to the user.

16. The computer system according to claim 15, the stored program instructions further comprising:
in response to determining to dispatch assistance to the user, program instructions to provide a dispatch unit to the geolocation of the user.

17. The computer system according to claim 15, the stored program instructions further comprising:
program instructions to query computing devices of one or more users for feedback corresponding to the user; and
program instructions to redefine the defined path of the unmanned vehicle based at least in part on the feedback of the one or more users.

18. The computer system according to claim 15, wherein determining whether to dispatch assistance to the user, further comprises:
program instructions to receive sensor information of a computing device of the user from the unmanned vehicle; and
program instructions to identify a fall event corresponding to the user based at least in part on the sensor information.

19. The computer system according to claim 18, the stored program instructions further comprising:
program instructions to capture images of an area corresponding to the fall event; and
program instructions to receive confirmation for dispatch assistance from the computing device of the user.

20. The computer system according to claim 15, wherein detecting the user within the threshold distance of the defined path, further comprises:
program instructions to transmit an assistance signal to one or more computing devices within the threshold distance of the defined path, wherein the threshold distance is based on communication capabilities of the unmanned vehicle; and
program instructions to receive confirmation of a response to the assistance signal from the unmanned vehicle.
